(19) United States
(12) Patent Application Publication
(10) Pub. No.: US 2017/0287320 A1
(43) Pub. Date: Oct. 5, 2017

(54) VEHICLE TRAILER COMMUNICATION

(71) Applicant: GM GLOBAL TECHNOLOGY OPERATIONS LLC, Detroit, MI (US)

(72) Inventors: GRANT L. MEADE, WHITBY (CA); VYACHESLAV BEREZIN, NEWMARKET (CA); CHARLES A. GREEN, CANTON, MI (US)

(73) Assignee: GM GLOBAL TECHNOLOGY OPERATIONS LLC, Detroit, MI (US)

(21) Appl. No.: 15/086,864

(22) Filed: Mar. 31, 2016

(51) Int. Cl. G08C 17/02; G07C 5/08; B60D 1/62

(52) U.S. Cl. CPC G08C 17/02; B60D 1/62; G07C 5/0816; G08C 2200/00

(57) ABSTRACT

Methods and systems are provided for facilitating communications between a vehicle and a trailer. In accordance with one embodiment, a system includes a memory, and a processor, and a transceiver. The memory is disposed onboard a trailer that is configured to be connected to a vehicle. The memory stores trailer-specific information pertaining to the trailer. The processor is disposed onboard the trailer, and is coupled to the memory. The processor is configured to provide instructions to automatically transmit the trailer-specific information to the vehicle, for customization of vehicle operation based on the trailer-specific information. The transceiver is coupled to the processor. The transceiver is configured to automatically transmit, based on the instructions provided by the processor, the trailer-specific information to the vehicle, for customization of vehicle operation based on the trailer-specific information for when the trailer is connected to the vehicle.

### TECHNICAL FIELD

The present disclosure generally relates to vehicles, and more particularly relates to communication between trailers and vehicles.

### BACKGROUND

Various trailers are manufactured today for use with vehicles. Typically the vehicle is connected to the trailer, and then transports the trailer along with the vehicle as the vehicle is driven. However, in certain instances it may be desirable to provide improved communication (e.g. improved digital communication) between trailers and vehicles.

Accordingly, it is desirable to provide improved techniques for providing communication with vehicle trailers. It is also desirable to provide methods and systems utilizing such techniques. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a system is provided. The system comprises a memory, and a processor, and a transceiver. The memory is disposed onboard a trailer that is configured to be connected to a vehicle. The memory stores trailer-specific information pertaining to the trailer. The processor is disposed onboard the trailer, and is coupled to the memory. The processor is configured to provide instructions to automatically transmit the trailer-specific information to the vehicle, for customization of vehicle operation based on the trailer-specific information. The transceiver is coupled to the processor. The transceiver is configured to automatically transmit, based on the instructions provided by the processor, the trailer-specific information to the vehicle, for customization of vehicle operation based on the trailer-specific information for when the trailer is connected to the vehicle.

In accordance with another exemplary embodiment, a method is provided. The system comprises obtaining, from a memory onboard a trailer that is configured to be connected to a vehicle, trailer-specific information pertaining to the trailer; and automatically transmitting, via instructions provided via a processor onboard the trailer to a transmitter onboard the trailer, the trailer-specific information to the vehicle, for customization of vehicle operation based on the trailer-specific information for when the trailer is connected to the vehicle.

In accordance with a further exemplary embodiment, a trailer is provided. The trailer comprises a connector, a memory, a processor, and a transmitter. The connector is configured to connect the trailer to a vehicle. The memory is disposed onboard the trailer, and is configured to store trailer-specific information pertaining to the trailer. The processor is disposed onboard the trailer and coupled to the memory, and is configured to provide instructions to automatically transmit the trailer-specific information to the vehicle, for customization of vehicle operation based on the trailer-specific information for when the trailer is connected to the vehicle. The transmitter is coupled to the processor, and is configured to automatically transmit, based on the instructions provided by the processor, the trailer-specific information to the vehicle, for customization of vehicle operation based on the trailer-specific information for when the trailer is connected to the vehicle.

### DESCRIPTION OF THE DRAWINGS

The present disclosure will hereinafter be described in conjunction with the following drawing figures, wherein like numerals denote like elements, and wherein:

FIG. 1 is a functional block diagram of a system that includes a vehicle and a trailer, the trailer having a communication module for communication with the vehicle, in accordance with an exemplary embodiment; and

FIG. 2 is a flowchart of a process for communicating between a trailer and a vehicle, such as the trailer and vehicle of FIG. 1, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

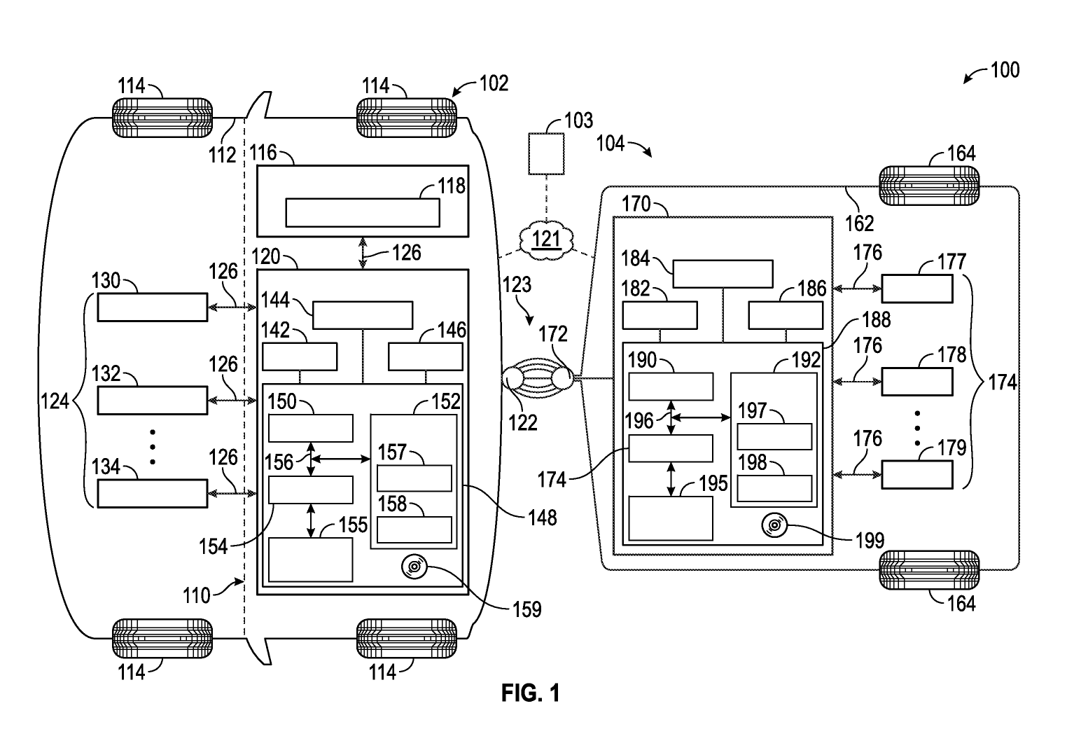

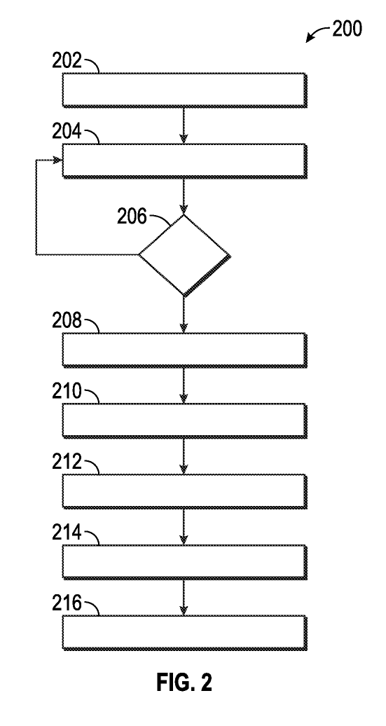

FIG. 1 illustrates a system 100 that includes a vehicle 102 and a trailer 104. As depicted in FIG. 2, the vehicle 102 and the trailer 104 are connected together via respective connectors 122, 172 and associated connecting wires 123, so that the trailer 104 moves along with the vehicle 102 as the vehicle 102 is driven.

It will be appreciated that the vehicle 102 and trailer 104 may comprise any one or more of a number of different types of vehicles and trailers, respectively. For example, the vehicle 102 may be any one of a number of different types of automobiles and/or other vehicle types. For example, in various embodiments, the vehicle 102 may comprise a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or any one of a number of other types of vehicles. Similarly, the trailer 104 may be any one of a number of different types of trailers pulled and/or transported by such a vehicle 102, including, by way of example only, trailers used to transport other automobiles, boats or other marine vehicles, other vehicles, cargo, and/or other devices and/or systems.

As described in greater detail further below, the vehicle 102 and the trailer 104 include respective control systems 120, 170 for two-way, intelligent communication between the vehicle 102 and the trailer 104. Specifically, as discussed further below, the control systems 120, 170 allow for intelligent communication in both directions between the vehicle 102 and the trailer 104, and allow for potentially improved configuration of the vehicle 102 and the trailer 104 and for improved control and operation of the vehicle 102 and the trailer 104.

As depicted in FIG. 1, the vehicle 102 includes, in addition to the above-referenced control system 120, a chassis 110, a body 112, a plurality of wheels 114, and a propulsion system 116. The body 112 is arranged on the chassis 110 and substantially encloses the other components of the vehicle 102. The body 112 and the chassis 110 may jointly form a frame. The wheels 114 are each rotationally coupled to the chassis 110 near a respective corner of the body 112. In various embodiments the vehicle 102 may differ from that depicted in FIG. 1. For example, in certain embodiments the number of wheels 114 may vary.

The propulsion system 116 powers the vehicle 102 via movement of the wheels 114. In various embodiments, the propulsion system 116 is part of an actuator assembly for powering movement of the vehicle. In one embodiment, the propulsion system 116 is mounted on the chassis 110, and drives the wheels 114.

In the depicted embodiment, the propulsion system 116 includes a motor and/or engine 118. In one embodiment, the motor/engine 118 comprises an electric motor/generator that is powered by a rechargeable energy storage system (RESS) (e.g., a vehicle battery) (not depicted). In other embodiments, the motor/engine 118 comprises another type of engine, such as a combustion engine that uses gasoline, natural gas, propane, one or more biofuels, and/or one or more other types of fuel. In other embodiments, the motor/engine 118 may include one or more other of these and/or other types of engines and/or motors. The motor/engine 118 is coupled to at least some of the wheels 114 through one or more drive shafts (not depicted). In some embodiments, the motor/engine 118 is mechanically coupled to the transmission. In other embodiments, the motor/engine 118 may instead be coupled to a generator used to power an electric motor that is mechanically coupled to the transmission. In certain other embodiments (e.g. electrical vehicles), an engine and/or transmission may not be necessary.

As noted above, the control system 120 facilitates control of communication with the trailer 104, via the respective control system 170 of the trailer 104. Also as noted above, the vehicle connector 122 physically connects the vehicle 102 with the trailer 104 via a connection between the vehicle connector 122 and the trailer connector 172 of FIG. 1 via various wires 123. In one embodiment, six wires 123 are utilized to connect the vehicle 102 and the trailer 104. However, the number of wires 123 may vary in other embodiments. Also in one embodiment: (i) a first wire 123 is used for running lights of the trailer 104; (ii) a second wire 123 is an auxiliary wire between the vehicle 102 and the trailer 104; (iii) a third wire 123 is used for controlling right turns and stops for the trailer 104; (iv) a fourth wire 123 is used for controlling electric brakes of the trailer 104; (v) a fifth wire 123 is used as a ground between the vehicle 102 and the trailer 104; and (vi) a sixth wire 123 is used for left turns and stops for the trailer 104. The function and/or arrangement of the wires 123 may also differ in various embodiments.

In addition to facilitating control of communications with the trailer 104, in various embodiments the control system 120 also facilitates control over the propulsion system 116 and various other vehicle modules 124 (or systems), for example as depicted in FIG. 1. In various embodiments, the control system 120 facilitates such control via communications along a vehicle bus 126 and/or other communication networks, devices, and/or systems of the vehicle 102. In one embodiment, the control system 120 is part of, and/or controls, in whole or in part, a control system for the propulsion system 116 (e.g. comprising an engine control system, or “ECS”). Also in various embodiments, the other modules 124 controlled via the control system 120 include a braking module 130, a steering module 132, and/or a lighting module 134, among various other possible modules.

The braking module 130 (or system) is mounted on the chassis 110, and provides braking for the vehicle 102. The braking module 130 receives inputs from the driver via a brake pedal (not depicted), and provides appropriate braking via brake units (also not depicted). The driver also provides inputs via an accelerator pedal (not depicted) as to a desired speed or acceleration of the vehicle, as well as various other inputs for various vehicle devices and/or systems, such as one or more vehicle radios, other entertainment systems, environmental control systems, lighting units, navigation systems, and the like (also not depicted). In certain embodiments, the vehicle 102 may utilize braking commands that are generated by a computer, with no involvement from the driver (e.g. for autonomous vehicles) and/or a combination of inputs from a user and a computer (e.g. via using user inputs as well as automatic braking as appropriate, and so on). In addition, in certain embodiments, the braking module 130 may be utilized to control braking of the trailer 104, for example via a braking module 177 of the trailer 104.

The steering module 132 (and/or system) is mounted on the chassis 110, and controls steering of the wheels 114. In the depicted embodiment, the steering module 132 includes a steering wheel and a steering column (not depicted). In certain embodiments, the vehicle 102 may utilize steering commands that are generated by a computer, with no involvement from the driver (e.g. for autonomous vehicles) and/or a combination of inputs from a user and a computer (e.g. via using user inputs as well as steering assist as appropriate, and so on). In addition, in certain embodiments, the steering module 132 may be utilized to control steering of the trailer 104, for example via a steering module 178 of the trailer 104.

The lighting module 134 (or system) is mounted on the chassis 110, and controls lighting for the vehicle 102. In the depicted embodiment, the lighting module 134 controls the lighting for the vehicle 102 based on user commands or inputs. In certain embodiments, the vehicle 102 may utilize lighting commands that are generated by a computer, with no involvement from the driver (e.g. for autonomous vehicles) and/or a combination of inputs from a user and a computer (e.g. via light settings that are dependent upon ambient lighting conditions and/or one or more other conditions, and so on). In addition, in certain embodiments, the lighting module 134 may be utilized to control lighting of the trailer 104, for example via a lighting module 179 of the trailer 104.

With reference again to the control system 120, in one embodiment the control system 120 is mounted on the chassis 110. Also in one embodiment, the control system 120 comprises a modem 142, a transceiver 144, various sensors 146, and a controller 148. In various embodiments, the control system 120, among other features, facilitates communications with the trailer 104, and implements information obtained from the trailer 104, for example in accordance with the steps of the process 200 described further below in connection with FIG. 2.

In various embodiments, the modem 142 facilitates communications with the trailer 104 as well as the dissemination of information (including trailer 104 specific information) throughout the vehicle 102. In one embodiment, the modem 142 comprises a power line communication (PLC) modem that is coupled between the vehicle bus 126 and the controller 148. In various other embodiments, one or more other forms of communication may be utilized (e.g. Wi-Fi, BlueTooth, and/or other wireless communications). Also in one embodiment, the modem 142 disseminates information (including trailer 104 specific information) throughout the vehicle 102 along the vehicle bus 126. In addition, in one embodiment, the modem 142 facilitates communications with the trailer 104 along with the transceiver 144. In various embodiments, the modem 142 performs these and other functions in facilitating communications with the trailer 104, among other features, for example in accordance with the steps of the process 200 described further below in connection with FIG. 2. In certain embodiments, the modem 142 may be interchangeable with the transceiver 144 discussed below (e.g. a single device may comprise the modem 142/transceiver 144, in one embodiment). In other embodiments, separate modems 142 and transceivers 144 may be utilized (e.g. in one embodiment the modem 142 may be used with wireless communications and the transceiver 144 may be used for wired communications). However, this may vary in other embodiments.

In various embodiments, the transceiver 144 also facilitates communications with the trailer 104, for example in concert with a respective transceiver 184 of the trailer 104. In various embodiments, the transceiver 144 may comprise any number of receivers, transmitters, and/or transceivers. In addition, in certain embodiments, the transceiver 144 may also facilitate dissemination of information (including trailer 104 specific information) throughout the vehicle 102. In certain embodiments, the transceiver 144 communicates with the transceiver 184 of the trailer 104 via a wired connection, for example via one or more of the wires 123. As used herein, the term “wire connection” may include, for example, power line communication technology, imprinting digital, Ethernet communications, and/or other communication types. In other embodiments, the transceiver 144 communicates with the transceiver 184 communicates with the transceiver 184 of the trailer 104, wirelessly, for example via a wireless network 121 as depicted in FIG. 1. In one embodiment, the wireless network 121 comprises a long-range cellular wireless (e.g. cellular) communication network. In another embodiment, the wireless network 121 comprises a short-range wireless (e.g. Bluetooth) communication network. In other embodiments, a combination of such wireless networks may be used, and/or one or more other different types of wireless networks may be used. In yet other embodiments, the transceivers 144 and 184 may communicate both via one or more wired connections and via one or more wireless networks. In certain embodiments, the transceiver 184 may communicate the trailer-specific information to one or more wireless devices 103, for example a smart phone, tablet, computer, and/or other electronic device of a driver and/or other user of the vehicle 102, via one or more wireless networks 121 (which may be the same or different as the wireless network(s) used to communicate with the vehicle 102). In addition, in various embodiments, the transceiver 144 also transmits information from the vehicle 102 to the trailer 104, for example including instructions from the processor 150 of FIG. 1 for operation and/or control for the trailer 104 based on the trailer-specific information. In various embodiments, the transceiver 144 performs these and other functions in facilitating communications with the trailer 104, among other features, for example in accordance with the steps of the process 200 described further below in connection with FIG. 2.

In various embodiments, the sensors 146 measure and/or obtain information pertaining to one or more devices, systems, and/or components of the vehicle 102. In For example, in certain embodiments, the sensors 146 may include steering one or more input sensors for measuring user inputs as to braking (e.g. via brake pedal position, travel, and/or force sensors), steering (e.g. via steering wheel sensors), lighting (e.g. light switch and/or light panel sensors), and/or one or more other types of inputs. In various embodiments, the sensors 146 may also include one or more other types of sensors, such as, by way of example only, wheel speed sensors, accelerometers, impact sensors, and/or one or more other types of sensors 146 that may be used in controlling one or more modules 124, for example using trailer 104 specific information obtained via the trailer 104. In various embodiments, the sensors 146 perform these and other functions in facilitating communications with the trailer 104, among other features, for example in accordance with the steps of the process 200 described further below in connection with FIG. 2.

The controller 148 is coupled to the modem 142, the transceiver 144, and the sensors 146. The controller 148 controls communication with the trailer 104. The controller 148 also utilizes the trailer-specific information obtained from the trailer 104, along with information obtained from the modem 142, the transceiver 144, and the sensors 146, in controlling various systems and modules for the vehicle 102, such as the propulsion system 116 and the other modules 124 of FIG. 1, as well as for controlling various systems and/or modules 170, 174 for the trailer 104. In various embodiments, the controller 148 performs these and other functions in facilitating communications with the trailer 104, among other features, for example in accordance with the steps of the process 200 described further below in connection with FIG. 2.

As depicted in FIG. 1, the controller 148 comprises a computer system. In certain embodiments, the controller 148 may also include one or more of the modem 142, transceiver 144, sensors 146, one or more other devices and/or systems, and/or components thereof. In addition, it will be appreciated that the controller 148 may otherwise differ from the embodiment depicted in FIG. 1. For example, the controller 148 may be coupled to or may otherwise utilize one or more remote computer systems and/or other control systems, and/or one or more other systems of the vehicle 102.

In the depicted embodiment, the computer system of the controller 148 includes a processor 150, a memory 152, an interface 154, a storage device 155, and a communication bus 156. The processor 150 performs the computation and control functions of the controller 148, and may comprise any type of processor or multiple processors, single integrated circuits such as a microprocessor, or any suitable number of integrated circuit devices and/or circuit boards working in cooperation to accomplish the functions of a processing unit. During operation, the processor 150 executes one or more programs 157 contained within the memory 152 and, as such, controls the general operation of the controller 148 and the computer system of the controller 148, generally in executing the processes described herein, such as the process 200 described further below in connection with FIG. 2.

The memory 152 can be any type of suitable memory. For example, the memory 152 may include various types of dynamic random access memory (DRAM) such as SDRAM, the various types of static RAM (SRAM), and the various types of non-volatile memory (PROM, EPROM, and flash). In certain examples, the memory 152 is located on and/or co-located on the same computer chip as the processor 150. In the depicted embodiment, the memory 152 stores the above-referenced program 157 along with one or more stored values 158.

The bus 156 serves to transmit programs, data, status and other information or signals between the various components of the computer system of the controller 148. The interface 154 allows communication to the computer system of the controller 148, for example from a system driver and/or another computer system, and can be implemented using any suitable method and apparatus. In one embodiment, the interface 154 obtains the various data from the sensors of the sensors 146. The interface 154 can include one or more network interfaces to communicate with other systems or components. The interface 154 may also include one or more network interfaces to communicate with technicians, and/or one or more storage interfaces to connect to storage apparatuses, such as the storage device 155.

The storage device 155 can be any suitable type of storage apparatus, including direct access storage devices such as hard disk drives, flash systems, floppy disk drives and optical disk drives. In one exemplary embodiment, the storage device 155 comprises a program product from which memory 152 can receive a program 157 that executes one or more embodiments of one or more processes of the present disclosure, such as the steps of the process 200 (and any sub-processes thereof) described further below in connection with FIG. 2. In another exemplary embodiment, the program product may be directly stored in and/or otherwise accessed by the memory 152 and/or a disk (e.g., disk 159), such as that referenced below.

The bus 156 can be any suitable physical or logical means of connecting computer systems and components. This includes, but is not limited to, direct hard-wired connections, fiber optics, infrared and wireless bus technologies. During operation, the program 157 is stored in the memory 152 and executed by the processor 150.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 150) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 148 may also otherwise differ from the embodiment depicted in FIG. 1, for example in that the computer system of the controller 148 may be coupled to or may otherwise utilize one or more remote computer systems and/or other control systems.

While the components of the control system 120 (including the modem 142, the transceiver 144, the sensors 146, and the controller 148) are depicted as being part of the same system, it will be appreciated that in certain embodiments these features may comprise two or more systems. In addition, in various embodiments the control system 120 may comprise all or part of, and/or may be coupled to, various other vehicle devices and systems, such as, among others, the propulsion system 116, one or more of the other modules 124, and/or one or more other systems and/or modules of the vehicle 102.

Also as depicted in FIG. 1, the trailer 104 includes, in addition to the above-referenced control system 170, a body 162 and four wheels 164. In one embodiment, the body 162 substantially encloses the other components of the trailer 104. In various embodiments the trailer 104 may differ from that depicted in FIG. 1. For example, in certain embodiments the number of wheels 164 may vary.

As noted above, the control system 170 facilitates control of communication with the vehicle 102, via the respective control system 120 of the vehicle 102. Also as noted above, the trailer connector 172 physically connects the trailer 104 with the vehicle 102 via a connection between the vehicle connector 122 and the trailer connector 172 of FIG. 1 via various wires 123, and also as described in greater detail above. In various embodiments the control system 170 is disposed onboard, and integrated with, the trailer 104.

In addition to facilitating control of communications with the vehicle 102, in various embodiments the control system 170 also facilitates control over one or more modules 174 of the trailer 104 (e.g. via instructions provided from the vehicle control system 120 to the trailer control system 170 for implementation with the trailer 104). Also in various embodiments, the modules 174 (or systems) include a braking module 177 (or system), a steering module 178 (or system), and/or a lighting module 179 (or system), among various other possible modules (or systems).

In one embodiment, the braking module 177 controls braking of the trailer 104 via instructions provided via the controllers 148 and/or 188. Also in one embodiment, the steering module 178 provides steering in accordance with instructions provided via the controllers 148 and/or 188. Also in one embodiment, the lighting module 179 provides lighting in accordance with instructions provided via the controllers 148 and/or 188.

In one embodiment the control system 170 comprises a modem 182, a transceiver 184, various sensors 186, and a controller 188. In various embodiments, the control system 170, among other features, facilitates communications with the vehicle 102, and provides trailer-specific information for the vehicle 102, for example in accordance with the steps of the process 200 described further below in connection with FIG. 2. Also in one embodiment, the control system 170 facilitates the carrying out of instructions provided by the control system 120 with respect to the trailer 104.

In various embodiments, the modem 182 facilitates communications with the vehicle 102, for example in concert with the respective modem 142 of the vehicle 102. In one embodiment, the modem 182 comprises a power line communication (PLC) modem onboard the trailer 104. In various other embodiments, one or more other forms of communication may be utilized (e.g. Wi-Fi, BlueTooth, and/or other wireless communications). In certain embodiments, the modem 182 may be interchangeable with the transceiver 184 discussed below (e.g. a single device may comprise the modem 182/transceiver 184, in one embodiment). In other embodiments, separate modems 182 and transceivers 184 may be utilized (e.g. in one embodiment the modem 142 may be used with wireless communications and the transceiver 184 may be used for wired communications). However, this may vary in other embodiments.

In various embodiments, the transceiver 184 facilitates communications with the vehicle 102, for example in concert with the respective transceiver 144 of the vehicle 102. In various embodiments, the transceiver 184 may comprise any number of receivers, transmitters, and/or transceivers. The transceiver 184 communicates various types of trailer-specific information for implementation and customization by the vehicle 102. In various embodiments, the trailer-specific information includes, among other potential types of information: (i) trailer dimensions (e.g., length, height, clearance, width, distance to axles(s)); (ii) trailer tongue interface information (e.g., ball height, ball diameter); (iii) trailer mass (e.g., unloaded, gross weight, axles limits); (iv) trailer tires (e.g., size, tire pressure settings, temperature ratings); (v) trailer type (e.g. major classification of family, such as utility camper, or the like); (vi) trailer viewing system configuration (e.g., mono, stereo, side, 360, internal); (vii) trailer braking system configuration (e.g., trailer brake pad wear indicator option, trailer EPB option); (viii) trailer weight sensing system configuration (e.g., trailer based axle mass measurement, trailer based tongue weight measurement); (ix) trailer state of health (e.g., seasonal trailer odometer, recertification date, tire replacement odometer, tire replacement date, wheel bearing odometer); and/or other types of information used to identify the trailer, configure vehicle 102 as it is connected to the trailer 104 (or prior to the connection between the vehicle 102 and the trailer 104), and for implementing the information and configurations in operating and controlling the vehicle 102 and the trailer 104. In certain embodiments, the trailer-specific information may also include other trailer-related information so long as the trailer 104 is connected to the vehicle 102, such as, by way of example, information pertaining to updated states of health for the trailer 104, updated tire conditions for the trailer 104, updated lighting conditions or usage for the trailer 104, other updated parameter values for the trailer 104, and so on. In addition, in various embodiments, the transceiver 184 also receives information from the vehicle 102, for example including instructions from the processor 150 of FIG. 1 for operation and/or control for the trailer 104 based on the trailer-specific information. In addition, in certain embodiments, certain of the trailer-specific information (e.g. the trailer dimensions, trailer tongue interface information, trailer mass, trailer tires, trailer type, trailer viewing system configuration, trailer braking system configuration, trailer weight sensing system configuration, and the trailer state of health) may be provided, in whole or in part, wirelessly from the trailer 104 to the vehicle 102 before the connection of the trailer is completed, for example to assist with the completion of the connection and/or for the operator to operator to understand if they have the correct configurations prior to coupling with the trailer 104.

In certain embodiments, the transceiver 184 communicates with the transceiver 144 of the vehicle 102 via a wired connection, for example via one or more of the wires 123. In other embodiments, the transceiver 184 communicates with the transceiver 144 communicates with the transceiver 144 of the vehicle 102, wirelessly, for example via a wireless network 121 as depicted in FIG. 1. In yet other embodiments, the transceivers 184 and 144 may communicate both via one or more wired connections and via one or more wireless networks. In addition, similar to the discussion further below, in certain embodiments the transceiver 184 may also communicate with one or more wireless devices 103, for example a smart phone, tablet, computer, and/or other electronic device of a driver and/or other user of the vehicle 102, via one or more wireless networks 121 (which may be the same or different as the wireless network(s) used to communicate with the vehicle 102).

In one embodiment, the trailer-specific information is transmitted from the trailer 104 to the vehicle 102 as soon as, or shortly after, the trailer 104 and the vehicle 102 are connected via the connectors 122, 172, for example as detected via one or more of the sensors 186. In another embodiment, the trailer-specific information is transmitted from the trailer 104 to the vehicle 102 as soon as, or shortly after, a request is received from the trailer 104 (e.g. from the transceiver 184) from the vehicle 102 (e.g. from the transceiver 144), for example during, or shortly before or shortly after, the connection of the vehicle 102 and the trailer 104. In either case, the trailer-specific information allows for a convenient “plug and play” functionality between the vehicle 102 and the trailer 104 for when the vehicle 102 and the trailer 104 are connected together, for example by eliminating or reducing the amount of manual work needed by a user for such configuration.

In various embodiments, the sensors 186 measure and/or obtain information pertaining to one or more devices, systems, and/or components of the trailer 104. For example, in certain embodiments, the sensors 186 may include one or more connection sensors for detecting when the trailer 104 is connected to the vehicle 102 via connectors 122, 172, one or more brake sensors for measuring a position or operation of brake units of the braking module 177, one or more wheel sensors measuring position or movement of the wheels 164, one or more light sensors measuring operation of one or more lights of the lighting module 179, and/or one or more other types of measurements pertaining to the trailer 104 and/or the operation thereof.

The controller 188 is coupled to the transceiver 184, and the sensors 186. The controller 188 controls communication with the vehicle 102, including the transmission of the trailer-specific information to the vehicle 102 as well as the implementation of any instructions from the vehicle 102 (e.g. from the controller 148 of the vehicle 102). In addition, in certain embodiments, the controller 188 facilitates the carrying out of instructions from the controller 148 pertaining to the trailer 104.

As depicted in FIG. 1, the controller 188 comprises a computer system. In certain embodiments, the controller 188 may also include one or more of the transceiver 184, sensors 186, one or more other devices and/or systems, and/or components thereof. In addition, it will be appreciated that the controller 188 may otherwise differ from the embodiment depicted in FIG. 1. For example, the controller 188 may be coupled to or may otherwise utilize one or more remote computer systems and/or other control systems, and/or one or more other systems of the trailer 104.

In the depicted embodiment, the computer system of the controller 188 includes a processor 190, a memory 192, an interface 194, a storage device 195, and a bus 196. The processor 190 performs the computation and control functions of the controller 188, and may comprise any type of processor or multiple processors, single integrated circuits such as a microprocessor, or any suitable number of integrated circuit devices and/or circuit boards working in cooperation to accomplish the functions of a processing unit. During operation, the processor 190 executes one or more programs 197 contained within the memory 192 and, as such, controls the general operation of the controller 188 and the computer system of the controller 188, generally in executing the processes described herein, such as the process 200 described further below in connection with FIG. 2.

The memory 192 can be any type of suitable memory. For example, the memory 192 may include various types of dynamic random access memory (DRAM) such as SDRAM, the various types of static RAM (SRAM), and the various types of non-volatile memory (PROM, EPROM, and flash). In certain examples, the memory 192 is located on and/or co-located on the same computer chip as the processor 190. In the depicted embodiment, the memory 192 stores the above-referenced program 197 along with one or more stored values 198 (e.g. various values comprising and/or pertaining to the trailer-specific information).

The bus 196 serves to transmit programs, data, status and other information or signals between the various components of the computer system of the controller 188. The interface 194 allows communication to the computer system of the controller 188, for example from a system driver and/or another computer system, and can be implemented using any suitable method and apparatus. In one embodiment, the interface 194 obtains the various data from the sensors of the sensors 186. The interface 194 can include one or more network interfaces to communicate with other systems or components. The interface 194 may also include one or more network interfaces to communicate with technicians, and/or one or more storage interfaces to connect to storage apparatuses, such as the storage device 195.

The storage device 195 can be any suitable type of storage apparatus, including direct access storage devices such as hard disk drives, flash systems, floppy disk drives and optical disk drives. In one exemplary embodiment, the storage device 195 comprises a program product from which memory 192 can receive a program 197 that executes one or more embodiments of one or more processes of the present disclosure, such as the steps of the process 200 (and any sub-processes thereof) described further below in connection with FIG. 2. In another exemplary embodiment, the program product may be directly stored in and/or otherwise accessed by the memory 192 and/or a disk (e.g., disk 199), such as that referenced below.

The bus 196 can be any suitable physical or logical means of connecting computer systems and components. This includes, but is not limited to, direct hard-wired connections, fiber optics, infrared and wireless bus technologies. During operation, the program 197 is stored in the memory 192 and executed by the processor 190.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 190) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 188 may also otherwise differ from the embodiment depicted in FIG. 1, for example in that the computer system of the controller 188 may be coupled to or may otherwise utilize one or more remote computer systems and/or other control systems.

While the components of the control system 170 (including the transceiver 184, the sensors 186, and the controller 188) are depicted as being part of the same system, it will be appreciated that in certain embodiments these features may comprise two or more systems. In addition, in various embodiments the control system 170 may comprise all or part of, and/or may be coupled to, various other trailer devices and systems, such as, among others, the modules 174 of the trailer 104.

FIG. 2 is a flowchart of a process 200 for facilitating communications between a trailer and a vehicle, in accordance with an exemplary embodiment. The process 200 can be implemented in connection with the vehicle 102 and the trailer 104 of FIG. 1, in accordance with an exemplary embodiment.

As depicted in FIG. 2, the process 200 includes the step of obtaining trailer-specific information (step 202). In various embodiments, the trailer-specific information includes information that distinguishes one particular trailer (e.g. the trailer 104 of FIG. 1) from other trailers, so that the vehicle can be customized accordingly once the trailer is connected thereto, as well as information regarding current and/or updated trailer states and/or trailer-related parameters. In certain embodiments, the trailer-specific information includes some or all of the following, among other possible trailer-specific information: (i) trailer dimensions (e.g., length, height, clearance, width, distance to axles(s)); (ii) trailer tongue interface information (e.g., ball height, ball diameter); (iii) trailer mass (e.g., unloaded, gross weight, axles limits); (iv) trailer tires (e.g., size, tire pressure settings, temperature ratings); (v) trailer type (e.g. major classification of family, such as utility camper, or the like); (vi) trailer viewing system configuration (e.g., mono, stereo, side, 360, internal); (vii) trailer braking system configuration (e.g., trailer brake pad wear indicator option, trailer EPB option); (viii) trailer weight sensing system configuration (e.g., trailer based axle mass measurement, trailer based tongue weight measurement); (ix) trailer state of health (e.g., seasonal trailer odometer, recertification date, tire replacement odometer, tire replacement date, wheel bearing odometer, and tire pressure). Also in various embodiments, the trailer-specific information may be obtained in any number of different manners, such as, by way of examples only, by a manufacturer during manufacturing, design, and/or testing of the trailer and/or trailer type; by a service center when the trailer is undergoing maintenance; via data collected via the control system 170 of FIG. 1, and so on. In one embodiment, the trailer-specific information is included on a bar code (e.g. on an end plate of the trailer 104) that can be scanned; however, this may vary in other embodiments. Also in certain embodiments, the trailer-specific information may include trailer parameters or information that is continuously updated, e.g. based on measurements of the sensors 186 and/or determinations made by the processor 190, for example including information pertaining to updated states of health for the trailer 104, updated tire conditions for the trailer 104, updated lighting conditions or usage for the trailer 104, other updated parameter values for the trailer 104, and so on.

The trailer-specific information is stored in memory (step 204). In one embodiment, the trailer-specific information of step 202 is stored as stored values 198 of the memory 192 of FIG. 1 onboard the trailer 104.

A request or other triggering event is received or detected (step 206). In certain embodiments, a request is received at the trailer 104 of FIG. 1 (e.g. via the transceiver 184 and/or modem 182 of FIG. 1) from the vehicle 102 of FIG. 1 (e.g. from the transceiver 144 and/or modem 142 of FIG. 1) for trailer-specific information. In certain embodiments, the request is transmitted by the vehicle 102 and received by the trailer 104 as the trailer 104 and the vehicle 102 are connected or are to be connected together, or shortly before or afterwards. In another embodiment, the triggering event occurs when it is detected that the trailer 104 is connected to the vehicle 102, for example as detected via the sensors 186 of FIG. 1 when the trailer 104 is connected to the vehicle 102 via the respective connectors 172, 122 of FIG. 1.

In one embodiment, step 206 includes a determination via a processor (such as the processor 190 of FIG. 1) that such a request or other triggering event has been received or detected. Until such a determination is made, the process returns to step 204. Once such a determination is made that such a request or other triggering event has been received or detected, the process proceeds to step 208, described directly below.

The trailer-specific information is retrieved from memory in step 208. In one embodiment, during step 208, the trailer-specific information of step 202 is retrieved from the memory 192 of FIG. 1 by the processor 190 of FIG. 1.

The trailer-specific information is transmitted from the trailer to the vehicle (step 210). In one embodiment, the trailer-specific information of step 202 is transmitted via the transceiver 184 of FIG. 1, via instructions provided by the processor 190 of FIG. 1, to the vehicle 102 of FIG. 1. In one embodiment, one or more wired transmissions are made via one or more of the wires 123 of FIG. 1. In another embodiment, one or more wireless transmissions are made via the wireless network 121 depicted in FIG. 1. In certain embodiments, both wired and wireless transmissions are made for the trailer-specific information. In one embodiment, the data is modulated in step 210 (e.g. by the processor 190 of FIG. 1) for transmission to the vehicle 102. In addition, in certain embodiments, the transceiver 184 may also communicate the trailer-specific information to one or more wireless devices 103, for example a smart phone, tablet, computer, and/or other electronic device of a driver and/or other user of the vehicle 102, via one or more wireless networks 121 (which may be the same or different as the wireless network(s) used to communicate with the vehicle 102). In addition, in certain embodiments, the trailer-specific information may continue to be transmitted so long as the trailer 104 is connected to the vehicle 102 (e.g. with information pertaining to updated states of health for the trailer 104, updated tire conditions for the trailer 104, updated lighting conditions or usage for the trailer 104, other updated parameter values for the trailer 104, and so on). In various embodiments, simultaneous wired and wireless connections may be utilized to provide opportunities of redundancy, for example to help confirm the connection activity, diagnostics, and ability to implement various strategies (e.g. cybersecurity strategies). In addition, in certain embodiments, certain of the trailer-specific information (e.g. the trailer dimensions, trailer tongue interface information, trailer mass, trailer tires, trailer type, trailer viewing system configuration, trailer braking system configuration, trailer weight sensing system configuration, and the trailer state of health) may be provided, in whole or in part, wirelessly from the trailer 104 to the vehicle 102 before the connection of the trailer is completed, for example to assist with the completion of the connection and/or for the operator to operator to understand if they have the correct configurations prior to coupling with the trailer 104. In certain embodiments, vehicle-specific information (e.g. pertaining to a towing capacity of the vehicle 102) may similarly be transferred to the trailer 104 (e.g. via the respective transceivers, modems, and/or wireless devices).

The trailer-specific information is received by the vehicle (step 212). In one embodiment, the trailer-specific information is received by the transceiver 144 of FIG. 1. In certain embodiments, the trailer-specific information is received or facilitated at least in part via the modem 142 and/or via instructions provided by the processor 150 of FIG. 1 (for example, for operation of the transceiver 144 and/or the modem 142 of FIG. 1). In certain embodiments, the modulated data of step 210 is de-modulated (e.g. by the processor 150 of FIG. 1) once received by the vehicle 102. In addition, in certain embodiments, the trailer-specific information may also be received via the wireless device 103 of FIG. 1. In certain embodiments, vehicle-specific information (e.g. pertaining to a towing capacity of the vehicle 102) may similarly be received by the trailer 104 (e.g. via the respective transceivers, modems, and/or wireless devices).

The vehicle is configured using the trailer-specific information (step 214). In various embodiments, operation of the propulsion system 116, and/or of one or more vehicle modules 124 of FIG. 1, are configured via instructions provided by the processor 150 of FIG. 1 based on the trailer-specific information. For example, in certain embodiments, the propulsion system 116 may be operated with an amount of power based on the trailer dimensions and/or other trailer-specific information. In certain embodiments, the braking and/or steering of the vehicle 102 and/or the trailer 104 may be operated at least in part based on the trailer dimensions and/or other trailer-specific information. In certain embodiments, the lighting of the trailer 104 may be operated at least in part based on lighting features and/or requirements of the trailer-specific information, and/or by monitoring the lighting status and/or usage of the lighting for the trailer 104. Also in certain embodiments, an odometer may also be configured based on wheel and/or tire information from the trailer-specific information. In addition, in certain embodiments, tire pressure settings may be configured or adjusted, and/or the current tire pressures for the trailer 104 may be monitored, using the trailer-specific information. In certain embodiments, the configuration may continue to be updated as additional trailer-specific information is obtained throughout the duration of the trailer 104 to the vehicle 102, for example for information pertaining to updated states of health for the trailer 104, updated tire conditions for the trailer 104, updated lighting conditions or usage for the trailer 104, other updated parameter values for the trailer 104, and so on. In addition, in certain embodiments, the user of the vehicle 102 may also run cross-checks and/or make manual configurations and/or adjustments based on trailer-specific information obtained via wired connectors 122 and 172 or the wireless device 103. In another embodiment, the vehicle 102's odometer may be used track accumulated mileage during a particular trailer 104's connection period with the vehicle 102, and then the trailer 104's odometer may be updated accordingly and stored in the memory 192 of the control system 170 of the trailer 104. In certain embodiments, vehicle-specific information (e.g. pertaining to a towing capacity of the vehicle 102) may similarly be used for configuring the trailer 104 and/or the vehicle 102, for example, by comparing the vehicle 102's towing capability with the gross weight of the trailer 104 to provide a check as to whether the towing capability of the vehicle 102 is exceeded, and to provide an alert accordingly if this is the case.

The configurations and trailer-specific information are implemented (step 216). In certain embodiments, the configurations of step 214 are implemented in step 216 by the processor 150 of FIG. 1, for example by sending instructions to the propulsion system 116, the other vehicle modules 124, and/or other systems of the vehicle 102 of FIG. 1, and via instructions provided to the control system 170 and/or to the modules 174 of the trailer 104 of FIG. 1 for operation of the trailer 104. For example, in various embodiments, during step 216, instructions from the processor 150 of FIG. 1 are used to provide control input parameters to the propulsion system 116, the braking module 130, the steering system 132, the lighting module 134, and/or other modules and/or systems of the vehicle 102, and/or to control operation of the control system 170, braking module 177, steering module 178, lighting module 179, and/or other systems and/or modules of the trailer 104 of FIG. 1. In certain embodiments, the implantation of the trailer-specific information in step 216 is made at least in part by transmission of instructions from the processor 150 for operation and/or control of the vehicle 102 and the trailer 104, based on the trailer-specific information, via the modem 142 and/or the transceiver 144 throughout the vehicle 102 (e.g. via the vehicle bus 126) and to the trailer 104 (e.g. via transmission via the transceiver 144 along the wireless network 121, where the transmission are received by the transceiver 184 and implemented by instructions provided by the processor 190, in one embodiment). In one embodiment, the trailer data comprises an input that is utilized by one or more control systems for adapting control of one or more features of the vehicle 102 and/or the trailer 104 (e.g. for the propulsion system 116, the braking module 130, the steering system 132, the lighting module 134, and/or other modules and/or systems of the vehicle 102, and/or the control system 170, braking module 177, steering module 178, lighting module 179, and/or other systems and/or modules of the trailer 104 of FIG. 1). In certain embodiments, one or more alerts or other actions may be performed based on vehicle-specific information (e.g. pertaining to a towing capacity of the vehicle 102), for example by providing the above-described alert if the towing capability of the vehicle 102 is exceeded by the gross weight of the trailer 104.

Accordingly, methods and systems are provided for facilitating communications between a trailer and a vehicle. The disclosed methods and systems provide for the transmission of trailer-specific information from the trailer to the vehicle as the vehicle is connected to the trailer, to provide for potentially improved configuration and implantation with the vehicle and the trailer, and to provide a “plug and play” feature for the vehicle and the trailer, for example by eliminating or reducing the amount of manual work needed by a user for such configuration. In addition, the disclosed methods and systems provide for automatic, intelligent two-way flow of information between the trailer and the vehicle.

It will be appreciated that the disclosed methods and systems may vary from those depicted in the Figures and described herein. For example, the vehicle 102, the trailer 104, the respective control systems 120, 170, and/or various components thereof may vary from that depicted in FIG. 1 and described in connection therewith. In addition, it will be appreciated that certain steps of the process 200 may vary from those depicted in FIG. 2 and/or described above in connection therewith. It will similarly be appreciated that certain steps of the methods described above may occur simultaneously or in a different order than that depicted in FIG. 2 and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

1. A system comprising:
a memory disposed onboard a trailer that is configured to be connected to a vehicle, the memory storing trailer-specific information pertaining to the trailer, the trailer-specific information comprising a trailer braking system configuration for the trailer;
a processor disposed onboard the trailer and coupled to the memory, the processor configured to provide instructions to automatically transmit the trailer braking system configuration, to the vehicle, for customization of vehicle operation based on the trailer braking system configuration; and
a transmitter coupled to the processor and configured to automatically transmit, based on the instructions provided by the processor, the trailer braking system configuration, to the vehicle, for customization of vehicle operation based on the trailer braking system configuration, for when the trailer is connected to the vehicle.

2. The system of claim 1, further comprising:
a sensor configured to detect when the trailer is connected to the vehicle;
wherein the processor is configured to provide instructions for the transmitter to automatically transmit the trailer-specific information, including the trailer braking system configuration, to the vehicle, for customization of vehicle operation based on the trailer-specific information, including the trailer braking system configuration, when it is detected that the trailer is connected to the vehicle.

3. The system of claim 1, wherein:
the transmitter is configured to receive a request from the vehicle;
wherein the processor is configured to provide instructions for the transmitter to automatically transmit the trailer-specific information, including the trailer braking system configuration, to the vehicle, for customization of vehicle operation based on the trailer-specific information, including the trailer braking system configuration, when the request is received from the vehicle.

4. The system of claim 1, wherein the transmitter is further configured to automatically transmit trailer tongue interface information from the trailer to the vehicle wirelessly prior to connection between the trailer and the vehicle.

5. The system of claim 1, wherein the transmitter is further configured to automatically transmit dimensions of the trailer from the trailer to the vehicle wirelessly prior to connection between the trailer and the vehicle.

6. The system of claim 1, wherein the transmitter is further configured to automatically transmit an identification of a type of the trailer from the trailer to the vehicle.

7. The system of claim 1, wherein the transmitter is further configured to automatically transmit information regarding tires of the trailer from the trailer to the vehicle.

8. The system of claim 1, wherein the transmitter is further configured to automatically transmit viewing system configuration information from the trailer to the vehicle.

9. The system of claim 1, wherein the transmitter is further configured to automatically transmit information regarding a state of health of the trailer from the trailer to the vehicle.

10. The system of claim 1, further comprising:
a receiver disposed onboard the vehicle and configured to receive the trailer-specific information, including the trailer braking system configuration, from the trailer; and
a second processor, the second processor disposed onboard the vehicle and configured to automatically configure operation of one or more modules of the vehicle based on the trailer-specific information, including the trailer braking system configuration.

11. A method comprising:
obtaining, from a memory onboard a trailer that is configured to be connected to a vehicle, trailer-specific information pertaining to the trailer, the trailer-specific information comprising health information of the trailer with values of one or more of the following: a seasonal trailer odometer; a recertification date; a tire replacement odometer; a tire replacement date; and a wheel bearing odometer, of the trailer; and
automatically transmitting, via instructions provided via a processor onboard the trailer to a transmitter onboard the trailer, the trailer-specific information to the vehicle, for customization of vehicle operation based on the trailer-specific information for when the trailer is connected to the vehicle.

12. The method of claim 11, further comprising:
detecting, via a sensor, when the trailer is connected to the vehicle;
wherein the step of automatically transmitting the trailer-specific information comprises automatically transmitting, via instructions provided via the processor onboard the trailer to the transmitter onboard the trailer, the trailer-specific information to the vehicle, for customization of vehicle operation based on the trailer-specific information, when it is detected that the trailer is connected to the vehicle.

13. The method of claim 11, further comprising:
receiving a request from the vehicle;
wherein the step of automatically transmitting the trailer-specific information comprises automatically transmitting, via instructions provided via the processor onboard the trailer to the transmitter onboard the trailer, the trailer-specific information to the vehicle, for customization of vehicle operation based on the trailer-specific information, when the request is received from the vehicle.

14.-19. (canceled)

20. A trailer comprising:
a braking system having a braking system configuration;
a connector configured to connect the trailer to a vehicle;
a memory disposed onboard the a trailer, the memory configured to store trailer-specific information pertaining to the trailer, the trailer-specific information comprising information as to the configuration of the braking system of the trailer;
a processor disposed onboard the trailer and coupled to the memory, the processor configured to provide instructions to automatically transmit the trailer-specific information, including the information as to the configuration of the braking system of the trailer, to the vehicle, for customization of vehicle operation based on the trailer-specific information, including the information as to the configuration of the braking system of the trailer, for when the trailer is connected to the vehicle; and
a transmitter coupled to the processor and configured to automatically transmit, based on the instructions provided by the processor, the trailer-specific information, including the information as to the configuration of the braking system of the trailer, to the vehicle, for customization of vehicle operation based on the trailer-specific information, including the information as to the configuration of the braking system of the trailer, for when the trailer is connected to the vehicle.

21. The method of claim 11, wherein:
the step of obtaining the trailer-specific information comprises obtaining, from the memory onboard the trailer, values of a seasonal trailer odometer of the trailer; and
the step of automatically transmitting the trailer-specific information comprises transmitting, via instructions provided via the processor onboard the trailer to the transmitter onboard the trailer, the values of the seasonal trailer odometer to the vehicle, for customization of vehicle operation based on the values of the seasonal trailer odometer for when the trailer is connected to the vehicle.

22. The method of claim 11, wherein:
the step of obtaining the trailer-specific information comprises obtaining, from the memory onboard the trailer, values of a wheel bearing odometer of the trailer; and
the step of automatically transmitting the trailer-specific information comprises transmitting, via instructions provided via the processor onboard the trailer to the transmitter onboard the trailer, the values of the wheel bearing odometer to the vehicle, for customization of vehicle operation based on the values of the wheel bearing odometer for when the trailer is connected to the vehicle.

23. The method of claim 11, wherein:
the step of obtaining the trailer-specific information comprises obtaining, from the memory onboard the trailer, values of a tire replacement odometer of the trailer; and
the step of automatically transmitting the trailer-specific information comprises transmitting, via instructions provided via the processor onboard the trailer to the transmitter onboard the trailer, the values of the tire replacement odometer to the vehicle, for customization of vehicle operation based on the values of the tire replacement odometer for when the trailer is connected to the vehicle.

24. The method of claim 11, wherein:
the step of obtaining the trailer-specific information comprises obtaining, from the memory onboard the trailer, values of a tire replacement date of the trailer; and
the step of automatically transmitting the trailer-specific information comprises transmitting, via instructions provided via the processor onboard the trailer to the transmitter onboard the trailer, the values of the tire replacement date to the vehicle, for customization of vehicle operation based on the values of the tire replacement date for when the trailer is connected to the vehicle.

25. The method of claim 11, wherein:
the step of obtaining the trailer-specific information comprises obtaining, from the memory onboard the trailer, values of a recertification date of the trailer; and
the step of automatically transmitting the trailer-specific information comprises transmitting, via instructions provided via the processor onboard the trailer to the transmitter onboard the trailer, the values of the recertification date to the vehicle, for customization of vehicle operation based on the values of the recertification date for when the trailer is connected to the vehicle.

26. The method of claim 11, wherein:
the step of obtaining the trailer-specific information comprises obtaining, from the memory onboard the trailer, each of the following: a seasonal trailer odometer; a recertification date; a tire replacement odometer; a tire replacement date; and a wheel bearing odometer, of the trailer; and
the step of automatically transmitting the trailer-specific information comprises transmitting, via instructions provided via the processor onboard the trailer to the transmitter onboard the trailer, each of the seasonal trailer odometer, the recertification date, the tire replacement odometer, the tire replacement date, and the wheel bearing odometer, of the trailer, for customization of vehicle operation based on the values of each of the seasonal trailer odometer, the recertification date, the tire replacement odometer, the tire replacement date, and the wheel bearing odometer, for when the trailer is connected to the vehicle.
